(19) United States
(12) Patent Application Publication
(10) Pub. No.: US 2020/0363230 A1
(43) Pub. Date: Nov. 19, 2020

(54) MAP DISPLAY SYSTEM AND MAP DISPLAY PROGRAM

(71) Applicants: AISIN AW CO., LTD., Anjo-shi (JP); TOYOTA JIDOSHA KABUSHIKI KAISHA, Toyota-shi (JP)

(72) Inventors: Kazuya UEDA, Okazaki (JP); Motoki TAKUNO, Okazaki (JP); Taiki NAKAMURA, Toyoake (JP); Xin JIN, Nagoya (JP)

(73) Assignees: AISIN AW CO., LTD., Anjo-shi (JP); TOYOTA JIDOSHA KABUSHIKI KAISHA, Toyota-shi (JP)

(21) Appl. No.: 16/856,456

(22) Filed: Apr. 23, 2020

(30) Foreign Application Priority Data
May 16, 2019 (JP) 2019-092652

(51) Int. Cl. G01C 21/36; G06T 11/60

(52) U.S. Cl. CPC G01C 21/3673; G01C 21/3626; G06T 11/60

(57) ABSTRACT

Map display systems and programs arrange each of a plurality of characters representing a route on a display so that an angle formed by a direction of a character and a direction of the route is equal to or less than a predetermined angle. The characters representing the route are arranged along a reference section that is a section of the route displayed on a map and that has a curvature radius equal to or more than a threshold radius.

### INCORPORATION BY REFERENCE

The disclosure of Japanese Patent Application No. 2019-092652, filed on May 16, 2019, including the specification, drawings and abstract, is incorporated herein by reference in its entirety.

### BACKGROUND

Related technical fields include map display systems and map display programs.

### RELATED ART

A technique for displaying a plurality of characters representing a route name along a route is known (see Japanese Patent Application No. 2018-518328 (unpublished patent application by an applicant of the present application)). In Japanese Patent Application No. 2018-518328, when the difference in directions between two consecutive characters is equal to or more than a threshold, the directions of the two characters are made the same by arranging the two characters along a single straight arrangement line. In this way, it is possible to avoid an angle between two consecutive characters from changing greatly, and it is possible to reduce the possibility that good appearance and legibility of the route name are reduced.

### SUMMARY

However, when the characters are arranged along the single straight arrangement line as in Japanese Patent Application No. 2018-518328, the directions of the characters can become greatly offset from the direction of the route, and positions of the characters can become greatly spaced away from the route. That is, when the ability of the character to follow the route is poor, it becomes difficult to recognize which route a character string placed on the map is representing.

Exemplary embodiments of the broad inventive principles described herein provide a technique in which followability of a character with respect to a route is compatible with good appearance and legibility of the character.

Exemplary embodiments provide map display systems and programs that arrange each of a plurality of characters representing a route on a display so that an angle formed by a direction of a character and a direction of the route is equal to or less than a predetermined angle. The characters representing the route are arranged along a reference section that is a section of the route displayed on a map and that has a curvature radius equal to or more than a threshold radius.

In the above configuration, since the characters are arranged so that the angle formed by the direction of the character and the direction of the line is equal to or less than the predetermined angle, followability of the character with respect to the route can be increased. Here, the reference section is a section in which the curvature radius is equal to or more than the threshold radius. That is, the reference section is a section in which the change in direction is more gradual than a certain reference. Thus, it is possible to reduce the difference in the directions between the characters when the characters representing the route are arranged along the reference section. Therefore, it is possible to achieve followability of the character with respect to the route compatible with good appearance and legibility of the characters.

Exemplary embodiments provide systems and programs that arrange each of a plurality of characters representing a route on a display so that an angle formed by a lateral direction of the character and a direction of the route is equal to or less than a predetermined angle. The characters representing the route are arranged along a reference section that is a section of the route displayed on a map and in which the characters representing the route are arranged so that a difference in the directions between the characters is equal to or less than a threshold angle.

In the above configuration, since the characters are arranged so that the angle formed by the direction of the character and the direction of the route is equal to or less than the predetermined angle, followability of the character with respect to the route can be increased. Further, since the characters representing the route are arranged along the reference section in which the difference in the directions between the characters is equal to or less than the threshold angle, it is possible to achieve followability of the character with respect to the route compatible with good appearance and legibility of the character.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a block diagram of a navigation system;

FIG. 2A is an explanatory diagram of text images;

FIG. 2B is a setting example of candidate sections;

FIG. 2C and FIG. 2D are explanatory diagrams of arranging characters;

FIG. 2E is a schematic diagram of a route;

FIG. 3A is a flowchart of a reference section setting processing; and

FIG. 3B is a flowchart of a map display processing.

### DETAILED DESCRIPTION OF EXEMPLARY EMBODIMENTS

Hereinafter, embodiments will be described in the following order.

### (1) Configuration of Navigation System

### (2) Reference Section Setting Processing

### (3) Map Display Processing

### (4) Other Embodiments

### (1) Configuration of Navigation System

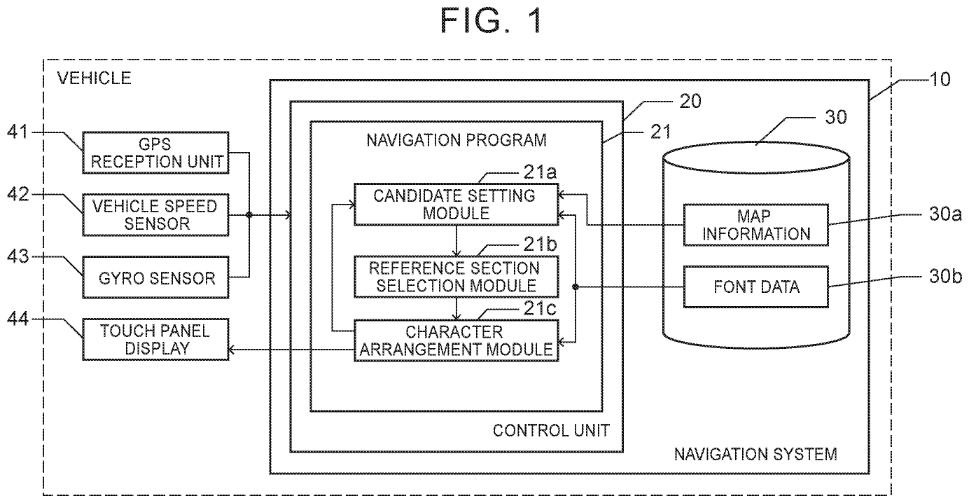

FIG. 1 is a block diagram illustrating a configuration of a navigation system 10 as a map display system according to one embodiment. The navigation system 10 is provided in a vehicle. The navigation system 10 has a control unit 20 and a recording medium 30. The control unit 20 has a central processing unit (CPU), a random access memory (RAM), a read-only memory (ROM), and the like, and executes a navigation program 21 recorded in the recording medium 30 or the ROM. As used herein, the term “recording medium” does not encompass transitory signals.

The recording medium 30 records map information 30a and font data 30b. The map information 30a includes link data that identifies links that connect two nodes, node data of positions of the nodes, and the like. The link corresponds to a route section in which the vehicle can travel, and the node corresponds to an intersection which is an end point of the link in a length direction. The node data includes information about an intersection corresponding to the node. The link data includes shape interpolation point data that indicates positions of shape interpolation points set in the middle of the links in the width direction. The link data includes information that indicates a route name of a route formed by the links. The route is formed by a plurality of continuous links.

The font data 30b is data that indicates the shape of each character that can be displayed by the navigation system 10. The control unit 20 generates a text image that is an image representing a character based on the font data 30b.

The vehicle has a GPS reception unit 41, a vehicle speed sensor 42, a gyro sensor 43, and a touch panel display 44. The GPS reception unit 41 receives radio waves from a GPS satellite and outputs signals for computing the current location of the vehicle via an interface not shown. The vehicle speed sensor 42 outputs signals corresponding to a rotational speed of wheels of the vehicle. The control unit 20 acquires a vehicle speed based on the signals from the vehicle speed sensor 42. The gyro sensor 43 detects an angular acceleration of the vehicle for a turn in a horizontal plane and outputs signals corresponding to a direction in which the vehicle is headed. The control unit 20 acquires a traveling direction of the vehicle based on the signals from the gyro sensor 43. The control unit 20 acquires the current location of the vehicle by identifying a traveling path of the vehicle based on the signals output from the vehicle speed sensor 42, the gyro sensor 43, and the like. Signals output from the GPS reception unit 41 are used for correcting the current location of the vehicle identified by the vehicle speed sensor 42, the gyro sensor 43, and the like.

The touch panel display 44 displays a map. The control unit 20 displays a map on the touch panel display 44 by outputting video signals indicating the map to the touch panel display 44.

The navigation program 21 includes a candidate setting module 21a, a reference section selection module 21b, and a character arrangement module 21c. The candidate setting module 21a, the reference section selection module 21b, and the character arrangement module 21c are program modules that cause the control unit 20 serving as a computer to function as a candidate setting unit, a reference section selection unit, and a character arrangement unit, respectively.

The processing of the navigation system 10 will be described below with an example of a case of displaying a map of the vicinity of a current location of the vehicle. With the function of the candidate setting module 21a, the control unit 20 sets a plurality of candidates (hereinafter, candidate sections) for the reference section on the route displayed on the map. With the function of the candidate setting module 21a, the control unit 20 sets the candidate sections for the route within a target mesh that is a mesh including a map display area. The map display area is an area in a real space that is represented on the map, and is an area that is set based on the current location of the vehicle.

The control unit 20 acquires a mesh to which the current location belongs or a mesh around the current location as the target mesh, and acquires information (node data, link data, and the like) on the target mesh from the map information 30a. The smaller the scale of the map to be displayed is, the wider the range may be for the mesh acquired as the target mesh by the control unit 20. The mesh is a square region having sides of a predetermined length.

The control unit 20 acquires the route existing in the target mesh and the route name based on the link data. The control unit 20 acquires continuous route sections associated with a common route name as one route, and acquires shape interpolation point data of the route sections configuring the route. Then, the control unit 20 acquires the shape of each route that is in the target mesh based on the shape interpolation point data. For example, the control unit 20 may acquire an approximate curve that approximates nodes on the route and the shape interpolation points, as the shape of the route. The control unit 20 acquires the shape of the route on the map when the route is displayed on the touch panel display 44 based on the scale of the map.

With the function of the candidate setting module 21a, the control unit 20 generates a text image for each character representing the route name of the route in the target mesh based on the font data 30b. The control unit 20 generates the text image of a size to be displayed on the touch panel display 44 based on a font size set beforehand by a user or the like.

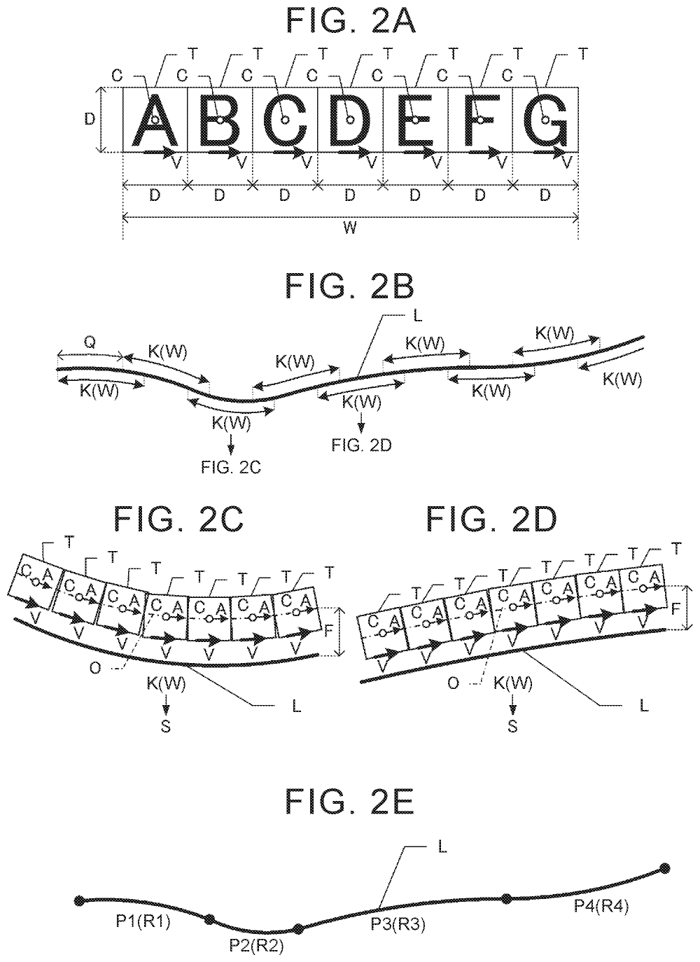

FIG. 2A illustrates text images T generated for a route name of a certain route in the target mesh. FIG. 2A illustrates the text images T of seven characters that configure a route name “ABCDEFG”. The text images T are each an image in which there are graphic elements (a straight line, a curve, and the like) that configure a character on a rectangular background area. The background area is transparent and the graphic elements that configure the character have a non-transparent font color. The background area is a square having sides of a length D. The center of gravity of the background area is represented as a center point C. For simplicity of illustration, the shape of the background region of all the characters is the same in FIG. 2A, but the shape of the background region (a length of a side, an aspect ratio, and the like) may be different for each character. A direction of a lower side of the background area is set as a direction V of the character.

With the function of the candidate setting module 21a, the control unit 20 generates a row of the text images T by arranging without gaps, the text images T of the characters representing the route name in the direction V of the character and acquires a length of the row of the text images T in the direction V of the character as a reference section length W. That is, the control unit 20 acquires the total value of widths of the text images T as the reference section length W. The reference section length W means the length of a character string of the characters representing the route name. In the present embodiment, the arrangement order of the characters is an order in which the first character is arranged at the left end and the subsequent characters are arranged sequentially rightward.

With the function of the candidate setting module 21a, the control unit 20 sets the candidate section on the route in the target mesh. The control unit 20 sets the candidate section having the length of the reference section length W. The control unit 20 sets the candidate section so that intervals between the candidate sections that are continuous in the direction of the route are equal to or less than the reference section length W.

FIG. 2B illustrates a setting example of a candidate section K. In FIG. 2B, on a route L, the candidate sections K having the reference section length W are set. An interval Q between start positions (for example, the left end of the paper) of the candidate sections K that are set continuously in the direction of the route L is the equal to or less than the reference section length W. Thus, the interval Q between the candidate sections K that are adjacent to each other on the route L is equal to or less than the length of the character string of the characters representing the route L. In the present embodiment, the interval Q is a length acquired by multiplying the reference section length W by a constant coefficient (0.75). The coefficient may be a decimal number greater than 0 and less than 1. Since the reference section length W differs for each route L, a setting cycle of the candidate section K also differs for each route L.

With the function of the character arrangement module 21c, the control unit 20 temporarily arranges each of the characters representing the route L so that an angle formed by the direction V of the character and the direction of the route L is equal to or less than a predetermined angle. In the present embodiment, the control unit 20 temporarily arranges the text images T indicating the route name along the candidate section K for each candidate section K. Arranging characters along the candidate section K is referred to as “temporarily arranging” and arranging characters along a reference section selected from the candidate sections K is referred to as “arranging”. The control unit 20 generates an offset line obtained by offsetting the route L by a predetermined offset distance in the candidate section K and temporarily arranges the text images T so that the center points C of the text images T are located on the offset line.

FIG. 2C and FIG. 2D illustrate temporary arrangement examples of the text images T. As illustrated in FIG. 2C and FIG. 2D, the text images T are temporarily arranged so that the center points C of the text images T are located on an offset line O (long dashed short dashed line) obtained by offsetting the route L by only an offset distance F in the candidate section K. In the present embodiment, the offset distance F is set to a length in which the route L and the text images T do not overlap, and is set to a length that is equal to or more than half of the sum of the width of the route L represented on the map and the length D of the side of the background area of the text images T. However, the route L and the text images T may overlap and the offset distance F may be 0.

The control unit 20 temporarily arranges the text images T so that the center points C are positioned on the offset line O, so as to maintain the interval between the center points C of the text images T (an average value of the lengths D of the sides of two continuous text images T) when the text images T are linearly arranged in the directions V of the characters without any gaps as illustrated in FIG. 2A. The control unit 20 acquires a direction A of the offset line O at each center point C and rotates the text image T so that the direction A of the offset line O at the center point C is the same as the direction V of the character. That is, the control unit 20 rotates the text image T so that the angle formed by the direction V of the character and the direction of the route L is a equal to or less than a predetermined angle (zero degrees that is a fixed angle, in the present embodiment).

With the function of the reference section selection module 21b, the control unit 20 selects a reference section S from the candidate sections K. Specifically, with the function of the reference section selection module 21b, the control unit 20 sets, as the reference section S, the candidate section K in which the difference in the directions between the characters is equal to or less than a threshold angle. The control unit 20 acquires as the difference in the directions V between the characters, the maximum value of the difference in the directions V between the two text images T that are temporarily arranged to be continuous along the candidate section K.

More specifically, the control unit 20 calculates for every combination, the difference between the direction V of an Mth text image T (M is a natural number) and the direction V of an (M+1)th text image T, and acquires the maximum value of all the calculated differences as the difference in the directions V between the characters. The control unit 20 then selects, as the reference section S, the candidate section K in which the difference in the directions V between the characters is equal to or less than the threshold angle (for example, 30 degrees).

The control unit 20 calculates the difference in the directions V between the characters for all the candidate sections K on all the routes L in the target mesh, and determines the candidate section K in which the difference in the directions V between the characters is equal to or less than the threshold angle as the reference section S. The control unit 20 records the difference in the directions V between the characters for each reference section S in the recording medium 30 and the like.

With the function of the reference section selection module 21b, the control unit 20 acquires the map display area. The map display area is the area in the real space that is represented on the map and is the area that is set based on the current location of the vehicle. The map display area is an area covered by the target mesh in which the reference section S is set. The control unit 20 sets the map display area based on the current location of the vehicle and the scale of the map. The map display area has a shape similar to the map display area on the touch panel display 44 (the size of the inverse multiple of the scale).

The control unit 20 sets the position and direction of the map display area based on the current position of the vehicle and the traveling direction of the vehicle so as to display a heading-up map in order to follow the current position of the vehicle. Specifically, the control unit 20 sets the map display area so that the current location of the vehicle is displayed at a constant position (for example, the center lower part) of the map display area on the touch panel display 44, and so that the traveling direction of the vehicle is directed toward the upper part of the touch panel display 44. Thus, each time the current position and the traveling direction of the vehicle are changed, the display area of the map is also changed.

With the function of the reference section selection module 21b, the control unit 20 extracts the reference sections S that are in the map display area. Then, for each route L in the map display area, the control unit 20 selects one by one, the reference section S in which the characters are actually arranged, out of the reference sections S. Specifically, the control unit 20 selects the reference section S in which the difference in the directions V between characters is the smallest, out of the reference sections S that are on the route L in the map display area.

When the reference section S is selected for each route L that is in the map display area in this way, the control unit 20 arranges each of the characters representing the route L along the selected reference section S, with the function of the character arrangement module 21c. The method of arranging the characters along the reference section S is the same as the method of performing the temporary arrangement described above. With the function of the character arrangement module 21c, the control unit 20 displays a route L, an intersection, and other features that are in the map display area, and also draws a map in which the text images T indicating the route name of the route L are arranged along the reference section S. The control unit 20 then generates control signals indicating the drawn map and outputs the control signals to the touch panel display 44.

In the present embodiment described above, the control unit 20 arranges each of the characters that represent the route L so that the angle formed by the direction V of the character and the direction of the route L is equal to or less than the predetermined angle (zero degrees that is a fixed angle, in the present embodiment). Further, the characters representing the route L are arranged along the reference section S in which the characters representing the route L are arranged so that the difference in the directions V between the characters is equal to or less than the threshold angle. In contrast, the characters representing the route L are not arranged along the section in which the characters representing the route L are arranged so that the difference in the directions V between the characters is larger than the threshold angle. Thus, it is possible to achieve followability of the character with respect to the route compatible with good appearance and legibility of the characters.

The reference section S in which the characters are arranged is a section in which the characters representing the route L are arranged so that the difference in the directions V between the characters is minimized. In this way, the characters representing the route L can be arranged along the reference section S in which the difference in the directions V between the characters is the smallest. Thus, it is possible to arrange the characters representing the route L at the positions in which the appearance and readability are the best.

The control unit 20 sets the candidate sections K on the route L displayed on the map and selects the reference section S from the candidate sections K. In this way, it is possible to set an extra number of candidate sections K beforehand and select a section with good appearance and legibility from the candidate sections K as the reference section S. Further, the interval Q between the consecutive candidate sections K on the route L is equal to or less than the length of the character string of the characters representing the route (reference section length W). Setting the candidate sections K at short intervals Q in this way makes it possible to increase the possibility that the candidate sections K correspond to positions where appearance and legibility of characters are improved.

### (2) Reference Section Setting Processing

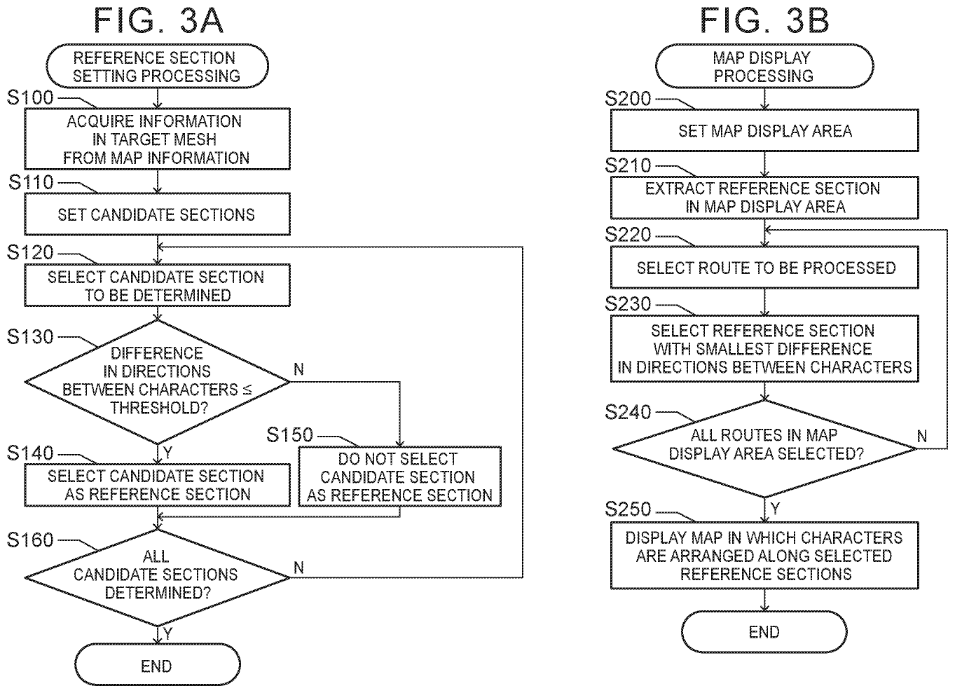

Next, a reference section setting processing executed with the function of the navigation program 21 will be described. FIG. 3A is a flowchart of the reference section setting processing. The reference section setting processing is a processing executed when a new map is displayed or when the target mesh changes in accordance with a change in the current location of the vehicle.

First, with the function of the candidate setting module 21a, the control unit 20 acquires information in the target mesh from the map information 30a (step S100). That is, the control unit 20 acquires information (node data, link data, and the like) of the target mesh from the map information 30a.

Next, with the function of the candidate setting module 21a, the control unit 20 sets the candidate sections K (step S110). That is, the control unit 20 acquires the length of the row of the text images T representing the route name for each route L in the target mesh as the reference section length W, and sets the candidate sections K having the length of the reference section length W on the route L at intervals Q shorter than the reference section length W (FIG. 2B).

Next, with the function of the reference section selection module 21b, the control unit 20 selects the candidate section K to be determined (step S120). That is, the control unit 20 selects one section that is to be determined whether to be selected as the reference section S, from the candidate sections K set in step S110. The candidate sections K may be selected in any order.

Next, with the function of the reference section selection module 21b, the control unit 20 determines whether the difference in the directions V between the characters is equal to or less than a threshold angle (step S130). That is, the control unit 20 temporarily arranges the text images T representing the route name along the candidate section K that is to be determined so that the angle formed by the direction V of the character and the direction A of the route L is equal to or less than a predetermined angle (zero degrees that is a fixed angle, in the present embodiment). Then, the control unit 20 determines whether the maximum value of the difference in the directions V of two consecutive text images T in the direction of the route L is equal to or less than a threshold angle (for example, 30 degrees).

When it is determined that the difference in the directions V between the characters is equal to or less than the threshold angle (step S130: Y), the control unit 20 selects the candidate section K as the reference section S with the function of the reference section selection module 21b (step S140). That is, the control unit 20 selects as the reference section S, the candidate section K in which the difference in the directions V between the characters is equal to or less than the threshold angle. The control unit 20 records the difference in the directions V between the characters in association with the reference section S.

In contrast, when it is not determined that the difference in the directions V between the characters is equal to or less than the threshold angle (step S130: N), the control unit 20 does not select the candidate section K as the reference section S with the function of the reference section selection module 21b (step S150). That is, the control unit 20 does not select as the reference section S, the candidate section K in which the difference in the directions V between the characters is larger than the threshold angle.

Finally, with the function of the reference section selection module 21b, the control unit 20 determines whether all the candidate sections K have been determined (step S160). That is, the control unit 20 determines whether the processing of determining whether to select as the reference section S has been completed for all the candidate sections K set in the target mesh in step S110.

When it is not determined that all the candidate sections K have been determined (step S160: N), the control unit 20 returns to step S120 and repeats the processing of determining whether to select the next candidate section K as the reference section S. In contrast, when it is determined that all the candidate sections K have been determined (step S160: Y), the control unit 20 ends the reference section setting processing.

### (3) Map Display Processing

Next, the map display processing executed with the function of the navigation program 21 will be described. FIG. 3B is a flowchart of the map display processing. The map display processing is a processing executed when a new map is displayed or the map display area changes in accordance with a change in the current position or the traveling direction of the vehicle, after the execution of the reference section setting processing.

First, with the function of the reference section selection module 21b, the control unit 20 acquires the map display area (step S200). That is, the control unit 20 sets the position and the direction of the map display area based on the current position of the vehicle and the traveling direction of the vehicle in order to display a heading-up map so as to follow the current position of the vehicle.

Next, with the function of the reference section selection module 21b, the control unit 20 extracts the reference section S in the display area (step S210). That is, the control unit 20 extracts the reference section S that is in the map display area among the reference sections S selected in step S140 of FIG. 3A.

Next, with the function of the reference section selection module 21b, the control unit 20 selects the route L to be processed (step S220). That is, the control unit 20 selects any one of the routes L that are in the display area as the route L to be processed. The routes L to be processed may be selected in any order.

Next, with the function of the reference section selection module 21b, the control unit 20 selects a reference section with the smallest difference in the directions V between the characters (step S230). That is, the control unit 20 selects the reference section S in which the difference in the directions V between the characters calculated in step S130 of FIG. 3A is the smallest, among the reference sections S of the route L to be processed. In this way, one reference section S has been selected for the route L to be processed.

Next, with the function of the reference section selection module 21b, the control unit 20 determines whether all the routes L in the map display area have been selected (step S240). That is, the control unit 20 determines whether the processing of selecting one reference section S has been completed for all the routes L in the map display area.

When it is not determined that all the routes L in the map display area have been selected (step S240: N), the control unit 20 returns to step S220 with the function of the reference section selection module 21b. That is, the control unit 20 repeatedly executes the processing of selecting the reference section S for the next route L.

In contrast, when it is determined that all the routes L in the map display area have been selected (step S240: Y), the control unit 20 displays the map in which the characters are arranged along the selected reference sections S with the function of the character arrangement module 21c (step S250). That is, the control unit 20 draws a map in which the text images T indicating the route names of the routes L are arranged along the reference sections S while indicating the routes L, intersections, and other features that are in the map display area. The control unit 20 then generates control signals indicating the drawn map and outputs the control signals to the touch panel display 44.

When the map is scrolled according to the current position of the vehicle or the map is scrolled according to an operation of the user, the map display processing is repeatedly executed and the map display area is continuously changed. Setting many reference sections S as in the present embodiment makes it possible to cause the reference section S in which characters are arranged to be transitioned in the scrolling direction so as to follow the scrolling movement. In this case, the reference section S is transitioned while the section in which the difference in the directions V between the characters is larger than the threshold angle is avoided.

### (4) Other Embodiments

In the above embodiment, the process of temporarily arranging the characters is performed to calculate the difference in the directions V between the characters when the characters are arranged. However, the process of temporarily arranging the characters does not always have to be performed. For example, the characters representing the route L may be arranged along the reference section S that is a section of the route L displayed on the map and that has a curvature radius equal to or more than a threshold radius. In order to arrange the characters in this way, the control unit 20 calculates the curvature radius for each section of the route L that is in the target mesh.

For example, the control unit 20 may acquire the shape of the route L by approximating the nodes and the shape interpolation points on the route L by an approximate curve formed by multiple arcs. In this way, a curvature radius of the section can be acquired for each section of the route L.

FIG. 2E illustrates how the route L illustrated in FIG. 2B is approximated by a plurality of arc sections P (P1 to P4). In each arc section P, a curvature radius R (R1 to R4) is constant. The control unit 20 calculates the curvature radius R of each arc section P and sets the reference section S in the arc section P in which the curvature radius R is equal to or more than the threshold radius. The control unit 20 sets the reference section S in the arc section P that is longer than the reference section length W. In FIG. 2E, the curvature radii R3 to R4 of the arc sections P3 to P4 are equal to or more than the threshold radius. In such a case, the control unit 20 sets the reference section S in each of the arc sections P3 to P4. The reference section S may be set at the center of the arc section P. When the arc section P has a length that is twice or more than the reference section length W, two or more reference sections S may be set in one arc section P.

When the reference section S is set as described above, with the function of the reference section selection module 21b, the control unit 20 selects the reference section S set on the arc section P having the maximum curvature radius among the reference sections S that are in the map display area. In this way, the selected reference section S can be set as the section of the route L displayed on the map and the section having the maximum curvature radius.

In the above configuration, the reference section S is the section in which the curvature radius R is equal to or more than the threshold radius. The reference section S is the section in which the change in direction is more gradual than a certain reference. Thus, it is possible to reduce the difference in the directions V between the characters when a plurality of characters representing the route L are arranged along the reference section S. In contrast, the characters representing the route L are not arranged along a section in which the curvature radius R is smaller than the threshold radius. Thus, it is possible to achieve followability of the character with respect to the route compatible with good appearance and legibility of the characters. Further, the characters representing the route L can be arranged along the reference section S in which the curvature radius R is the largest in the route L and the difference in the directions V between the characters is the smallest. Thus, it is possible to arrange the characters representing the route L at the positions in which the appearance and readability are the best.

In addition, by setting the reference section S in the arc section P (setting the reference section S so as not to extend over the plurality of arc sections P), it is possible to prevent a bending direction from being reversed in one reference section S. In FIG. 2E, the curvature centers of the arc sections P1 and P3 are below the route L, whereas the curvature centers of the arc sections P2 and P4 are above the route L. For example, when the reference section S is set so as to extend over the arc sections P1 and P2, the bending direction is reversed in the reference section S. When the bending direction is reversed in the reference section S, the direction in which the direction V of the character is inclined is also reversed.

Here, in the reference section S of FIG. 2C, the curvature center is located above the route L and the directions V of the characters are rotated counterclockwise from the direction V of the character on the immediate left. In contrast, in the reference section S of FIG. 2D, the curvature center is located below the route L and the directions V of the characters are rotated clockwise from the direction V of the character on the immediate left. Setting the reference section S in the arc section P makes it is possible to prevent the rotation direction of the direction V of the character from being reversed in the middle of one reference section S and to arrange the characters representing the route to a position at which appearance and legibility are improved.

The control unit 20 may arrange the characters along the plurality of reference sections S for one route L. That is, since the reference section S is the section in which appearance and legibility of the characters are known to be satisfactory, the characters do not necessarily have to be arranged in one limited reference section S in which the appearance and readability of the characters are satisfactory. For example, the control unit 20 may arrange the characters in the reference section S that is located at a position closer to the center or an outer edge of the map display area than a certain reference. Further, the control unit 20 may arrange the characters in the reference section S in which the shortest distance to another route L or the distance to an intersection is larger than a certain reference. In addition, the control unit 20 may arrange the character in the reference section S in which the distance to the current position of the vehicle is the closest to the certain reference distance, or the reference section S in which the distance to the current position of the vehicle is equal to or more than a certain reference.

The navigation system 10 may arrange the characters along the reference section S by referring to the map information 30a in which the reference sections S are defined beforehand. That is, the reference sections S may be defined in the map information 30a from the beginning and the control unit 20 may select the reference section S in the display area when the map display area is acquired. In this way, the processing load when displaying a map can be reduced.

In the above embodiment, each character is arranged so that the difference in the direction V of the character and the direction of the route L is zero degrees. However, the control unit 20 may arrange the character so that the difference in the direction V of the character and the direction of the route L is 90 degrees. For example, when the route L is represented at an angle close to the up-down direction on the map (for example, within 45 degrees from the up-down direction), it is possible to display the route name in vertical writing by arranging the characters in order from the top so that the direction V of the character and the direction of the route L are at 90 degrees. In this case, the control unit 20 may acquire the total value of the vertical lengths of the text images T as the reference section length W.

The map display system need only be a system capable of displaying a map on a display unit, and may be a device having a display unit, or may be a device that transmits image data indicating a map to a device having a display unit. The map display system may display a map visually recognized by an occupant of the vehicle, may be a part of the vehicle, may be a vehicle-mounted device mounted on the vehicle, or may be a smartphone.

The route is a feature that is linearly expressed on the map, and may be a road, a railway line, or a sea route. The direction of the route is the direction of the route at the position where the character is arranged, and may be the direction of the route at the position closest to the character, for example. The direction of the character is, for example, a vertical direction or a lateral direction of the character, and may be the axial direction of a coordinate system that defines the font shape. The predetermined angle serving as an angle formed by the direction of the character and the direction of the route may be set so that the characters arranged along one reference section are visually recognized as a series of words or the like, or may be set so as to appear in parallel. Thus, the predetermined angle in each of the characters may be a fixed angle or angles close to each other. Further, in order to set the predetermined angle so that the characters are visually recognized as a series of words or the like, it is preferable that the predetermined angle be a small value, a value such as 5°, 10°, or 15°. In such a case, the value equal to or less than the predetermined angle may be any value equal to or less than the predetermined angle such as 0°, 1°, 2°, 3°, 6°, 12°, or the like. The predetermined angle may be an angle that depends on the direction of the route of the entire reference section, may be different for each reference section in one route, or may be different for each route. Of course, the predetermined angle may be a common angle in the reference section of all the routes in the map.

The character arrangement unit need only arrange the characters along the route and may arrange the characters so that the distance between the route and the characters is constant. For example, the character arrangement unit may arrange the characters on the route by setting the distance between the center line of the route and the center of the character to zero. Further, the character arrangement unit may set the distance between the route and the character so that the route and the character do not overlap.

The reference section is a section that forms a part of the route and is a section in which the curvature radius is equal to or more than the threshold radius. The reference section is a section having a length in which the characters representing the route can be arranged and may have the same length as the length of the character string representing the route. The curvature radius of the reference section may be the average value of the curvature radii of small sections acquired by dividing the reference section into unit lengths or may be the minimum value. The curvature radius of the reference section may be a radius at which the difference in the directions between the characters when the characters representing the route are arranged along the reference section is equal to or less than the threshold angle. While the characters representing the route are arranged along the reference sections that are sections of the route displayed on the map and that are sections in which the curvature radius is equal to or more than the threshold radius, the characters representing the route are not arranged along the sections that are the sections of the route displayed on the map and in which the curvature radius is less than the threshold radius.

Further, the reference section may be the section that is the section of the route displayed on the map and that has a maximum curvature radius. In this way, the characters representing the route can be arranged along the reference section in which the curvature radius is the largest in the route and the difference in the directions between the characters is the smallest. Thus, the characters representing the route can be arranged at the position where the appearance and readability are the best.

Further, the direction of the character when the characters representing the route are arranged may be calculated, and the reference section may be set in the section where the difference between the calculated directions is equal to or less than the threshold angle. Here, the difference in the directions between the characters may be a difference in direction of two consecutive characters, or may be an average value or a maximum value of a difference in the directions of two consecutive characters. Further, the difference in the directions between the characters may be the difference in the rotation directions of the characters. For example, when the number of times the rotation direction of the (M+1)th character is reversed with respect to the Mth character is equal to or less than a threshold, the difference in the directions between the characters may be considered to be equal to or less than the threshold angle. Reversing the rotation direction means that switching occurs between clockwise and counterclockwise directions. The characters representing the route are arranged along the reference section that is the section of the route displayed on the map and in which the characters representing the route are arranged so that the difference in the directions between the characters is equal to or less than the threshold angle. In contrast, the characters representing the route are not arranged along the section in which the characters representing the route are arranged so that the difference in the directions between the characters is larger than the threshold angle.

The reference section may be the section of the route displayed on the map, and may be the section in which the characters representing the route are arranged so that the difference in the directions between the characters is the smallest. In this way, the characters representing the route can be arranged along the reference section in which the difference in the directions between the characters is the smallest. Thus, the characters representing the route can be arranged at the position where the appearance and readability are the best.

The map display system may further include: a candidate setting unit that sets the candidates for the reference section on the route displayed on the map; and a reference section selection unit that selects the reference section from the candidates for the reference section. In this configuration, it is possible to set an extra number of candidates for the reference section beforehand and select from them, the section having good appearance and legibility as the reference section.

The intervals between the candidates for the reference section that are continuous on the route may be equal to or less than the length of the character string of the characters representing the route. Setting the candidates for the reference section at short intervals in this way makes it possible to increase the possibility that the candidates for the reference section correspond to positions where appearance and legibility of characters are satisfactory.

Further, the method of setting the reference section in which characters are arranged so that appearance and legibility of the characters are satisfactory can also be applied as a program or a method. The system, the program, and the method described above include various aspects such as those implemented using a single device and those implemented utilizing parts that are common to various members provided in the vehicle. For example, it is possible to provide a navigation system, a map display system, a map display system method, or a map display system program having the above device. Various changes may be made. For example, some units may be implemented using software, and the others may be implemented using hardware. Further, a recording medium of a program for controlling a device may be provided that implements one or more of the functions described herein. The software recording medium may be a semiconductor memory or may be a magneto-optical recording medium. The same applies to any recording medium that will be developed in the future.

What is claimed is:

1. A map display system comprising:
a processor programmed to arrange each of a plurality of characters representing a route on a display so that an angle formed by a lateral direction of the character and a direction of the route is equal to or less than a predetermined angle;
wherein the characters representing the route are arranged along a reference section that is a section of the route displayed on a map and that has a curvature radius equal to or more than a threshold radius.

2. The map display system according to claim 1, wherein the characters representing the route are not arranged in a section that is a section of the route displayed on a map and that has a curvature radius less than the threshold radius.

3. The map display system according to claim 1, wherein the reference section is a section that is a section of the route displayed on the map and that has a maximum curvature radius.

4. A map display system comprising:
a processor programmed to arrange each of a plurality of characters representing a route on a display so that an angle formed by a lateral direction of the character and a direction of the route is equal to or less than a predetermined angle;
wherein the characters representing the route are arranged along a reference section that is a section of the route displayed on a map and in which the characters representing the route are arranged so that a difference in directions between the characters is equal to or less than a threshold angle.

5. The map display system according to claim 4, wherein the characters representing the route are not arranged along a section that is a section of the route displayed on a map and in which the characters representing the route are arranged so that the difference in the directions between the characters is more than the threshold angle.

6. The map display system according claim 4, wherein the reference section is a section of the route displayed on the map and a section in which the characters representing the route are arranged so that the difference in the directions between the characters is smallest.

7. The map display system according to claim 1, wherein the processor is programmed to:
set a plurality of candidates for the reference section in the route displayed on the map; and
select the reference section from the candidates for the reference section.

8. The map display system according to claim 7, wherein an interval between the candidates for the reference section that are continuous on the route is equal to or less than a length of a character string of the characters representing the route.

9. The map display system according to claim 4, wherein the processor is programmed to:
set a plurality of candidates for the reference section in the route displayed on the map; and
select the reference section from the candidates for the reference section.

10. The map display system according to claim 9, wherein an interval between the candidates for the reference section that are continuous on the route is equal to or less than a length of a character string of the characters representing the route.

11. A computer-readable storage medium storing a computer-executable map display program that causes a computer to perform functions comprising:
arranging each of a plurality of characters representing a route on a display so that an angle formed by a lateral direction of the character and a direction of the route is equal to or less than a predetermined angle;
wherein the characters representing the route are arranged along a reference section that is a section of the route displayed on a map and that has a curvature radius equal to or more than a threshold radius.

12. A computer-readable storage medium storing a computer-executable map display program that causes a computer to perform functions comprising:
arranging each of a plurality of characters representing a route on a display so that an angle formed by a lateral direction of the character and a direction of the route is equal to or less than a predetermined angle;
wherein the characters representing the route are arranged along a reference section that is a section of the route displayed on a map and in which the characters representing the route are arranged so that a difference in the directions between the characters is equal to or less than a threshold angle.
